(19) United States
(12) Patent Application Publication
(10) Pub. No.: US 2023/0326291 A1
(43) Pub. Date: Oct. 12, 2023

(54) METHOD AND SYSTEM FOR TRACKING GAME ASSET INTERESTS AND ALLOCATING EARNINGS ASSOCIATED THEREWITH

(71) Applicant: Super Money Games, Inc., Las Vegas, NV (US)

(72) Inventors: Sameer Mohan Gupta, Las Vegas, NV (US); Bryan O'Reilly, Las Vegas, NV (US); Andrew Costello, Las Vegas, NV (US)

(21) Appl. No.: 18/126,539

(22) Filed: Mar. 27, 2023

Related U.S. Application Data
(60) Provisional application No. 63/327,914, filed on Apr. 6, 2022.

(51) Int. Cl. G07F 17/32; G06Q 40/12; G06Q 50/34

(52) U.S. Cl. CPC G07F 17/3244; G06Q 40/12; G06Q 50/34; G06Q 2220/00

(57) ABSTRACT

Methods and systems are provided for tracking game asset interests, such as represented as NFTs, and allocating earnings associated with those interests. The game asset interest may represent an interest in the earnings associated with one or more wagering games (such as one or more online wagering games, table games or gaming machine games) over a designated period of time. A holder of a game asset interest may receive an allocation of the earnings associated with their interest.

### RELATED APPLICATION DATA

This application claims priority to U.S. Provisional Application Ser. No. 63/327,914, filed Apr. 6, 2022, which application is incorporated herein by reference in its entirety.

### FIELD OF THE INVENTION

The present invention relates to gaming machines and gaming systems which present wager-based games, such as for monetary value prizes or awards.

### BACKGROUND OF THE INVENTION

Currently, users can play house-banked games to win or lose money, but users cannot effectively take the “other side” of the bet or contest—aka the “house side” or the game owner or operator's monetary outcomes. For example, a user can play blackjack to win or lose against the dealer, but the player cannot be the dealer. Similarly, a player can play a slot machine to win or lose money, but cannot benefit from the “house hold” or long-term mathematical advantage of the slot machine operator. For all current chance-based and skill-based games, users can participate as players with odds that over the long term favor the game operator. But, users cannot participate as the game operator, resulting in a long-term disadvantage to the user.

Some games, such as Baccarat or Craps, have bets that seem like the player can bet on the house odds. In the case of Baccarat, a player can bet on the “Banker.” In the case of Craps, a player can bet on the “Don't Pass” line. However, in both of these cases, there is still a “house advantage” because the “Banker” and “Don't Pass” bets do not track the odds that the game operator actualizes. In the case of the “Banker,” the payout for bets is 95% instead of 100%. In the case of the “Don't Pass” bet, the odds are still slightly in the house's favor as the payouts are slightly less than the expected payout, with actual odds of the winning this bet are 976:949, versus a realized 1:1 payout, resulting in a difference of 1.36% as the house edge.

Moreover, these bets must be made at the time of gameplay and cannot be aggregated, meaning there is no way to assume the risk or reward of the game owner or operator over any extended gameplay without being the game owner or operator.

### SUMMARY OF THE INVENTION

Embodiments of the invention comprise methods and systems for tracking game asset interests, such as represented as non-fungible tokens (NFTs), and allocating earnings associated with those interests. The game asset interest may represent an interest in the earnings associated with one or more wagering games or devices (such as one or more online wagering games, table games or gaming machines) over a designated period of time. A holder of a game asset interest may receive an allocation of the earnings associated with their interest. In one embodiment, the game asset interest may be tracked in a Blockchain format.

In one embodiment, a system for tracking casino game asset interests and allocating earnings associated therewith comprises at least one external server comprising a processor, a memory and machine-readable code stored in the memory and executable by the processor to cause the server to: receive information which identifies a game asset interest, create a record regarding the game asset interest, the record comprising an initial block having the information which identifies the game asset interest and first time information associated therewith, transmit information regarding the initial block to at least one other computing device for decentralized storage, receive information regarding earnings associated with the game asset interest during a period of time, create a second block for the record, the second block having the information regarding the earnings and second time information associated therewith, transmit information regarding the second block to the at least one other computing device, determine a payment amount based upon the earnings, create a third block for the record, the third block having the information regarding the payment amount and third time information associated therewith, and transmit information regarding the third block to the at least one other computing device.

In one embodiment, the server may be configured to receive information regarding the transfer of the game asset interest and create a record regarding the transfer, where such information may identify a new owner thereof.

In one embodiment, the information which identifies the game asset interest may be an NFT, which NFT may be transferred, such as by sale from one party to another.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a system of the present invention; and

FIG. 2 is a flow diagram of a method of an embodiment of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods and systems for tracking game asset interests, such as represented as NFTs, and allocating earnings (which may be positive or negative) associated with those interests. The game asset interest may represent an interest in the earnings associated with one or more wagering games (such as one or more online wagering games, table games or gaming machine games) over a designated period of time. A holder of a game asset interest may receive an allocation of the earnings associated with their interest.

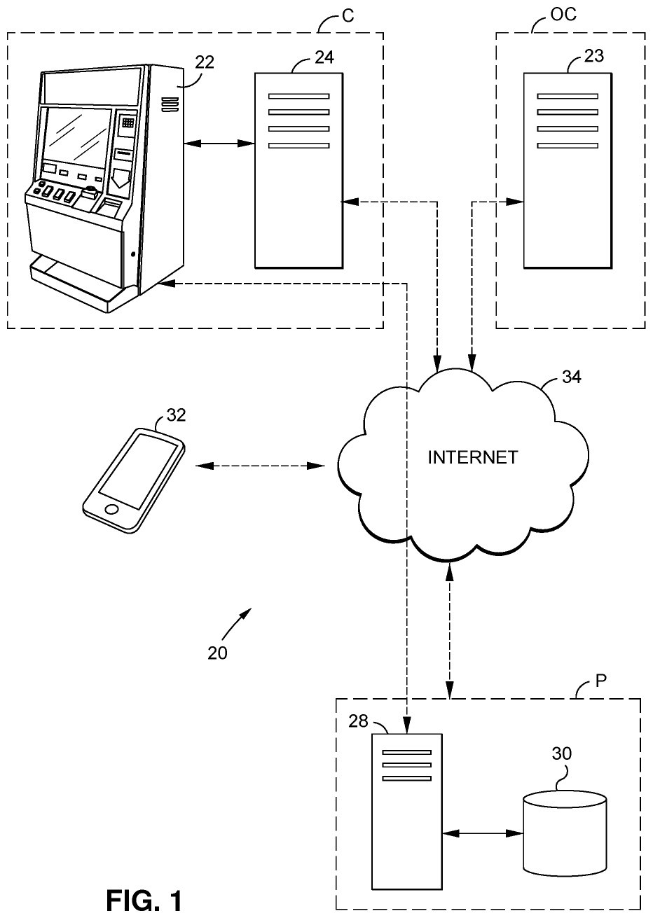

One embodiment of a system 20 of the invention is illustrated in FIG. 1. The system 20 may include one or more gaming devices or systems via which one or more wagering games are presented to players. For example, the system may include a casino gaming system C. This system C may include a plurality of gaming devices, such as one or more gaming machines 22. These gaming machines 22 may be configured to present any number of wager-based games that offer monetary (or monetary-value) prizes or awards, such as for winning outcomes. Such games include, but are not limited to, video poker, video blackjack, video slot, rotating-reel slot and other types of games. The casino gaming system C may include other types of gaming devices such as gaming tables and the like, at which one or more games are presented (such as craps, baccarat, roulette, etc.). These games may comprise games of chance, skill-based games, or combinations thereof (and may comprise single player or multiple player games, banks of games or the like, including games such as described in U.S. Patent Application Publication 2021/0312767 (U.S. Application Ser. No. 17,534,118, filed Oct. 7, 2021), which is co-owned with the present application and which is incorporated herein by reference in its entirety).

The casino gaming system C may include a wide variety of other features or elements. For example, the casino gaming system C may include one or more casino servers 24. The casino server 24 may comprise one or more processors or controllers, at least one communication device or interface, a database or other data storage device, and one or more additional memory or data storage devices (such as separate from the database). In one or more embodiments, the processor(s) is configured to execute one or more instructions, such as in the form of machine readable code (i.e. “software”), to allow the server 24 to perform various functionality, such as the functionality described herein. The software is preferably non-transitory, such as by being fixed in a tangible medium. For example, the software may be stored in the one or more memory devices. One or more of the memory devices may be read-only. In addition, the software may be stored on a removable medium in some embodiments. In general, the one or more memory devices are used as temporary storage. For example, the one or more memory devices may be random access memory or cache memory used to temporarily store some user information and/or instructions for execution by the at least one processor.

The software may comprise one or more modules or blocks of machine readable code. Each module may be configured to implement particular functionality when executed by the one or more processors, and the various modules may work together to provide overall integrated functionality. Of course, in certain embodiments, it is also possible for various of the functionality to be implemented as hardware, i.e. a processor or chip which is particularly designed to implement various of the functionality described herein.

In one embodiment, the casino server 24 may include (or be linked communicatively at one or more times to) one or more input and/or output devices, such as a keyboard, mouse, touchscreen, video display or the like, whereby the processor may receive information from an operator or servicer of the server 24 and/or output information thereto. This allows, for example, an operator of the server 24 to interface with the server 24 to upgrade, maintain, monitor, etc., it. In other embodiments, an operator might interface with the server 24 via a separate workstation or other device.

In one embodiment, the processor and other elements of the server 24 may be linked and thus communicate over one or more communication buses. In this manner, for example, the processor may read/receive software from the memory for execution, receive inputs and provide outputs to the various I/O devices, receive information from or output information to external devices via the communication interface, etc. The one or more communication devices or interfaces permit the server 24 to communicate with the gaming machines 22 or other gaming devices, and preferably external devices, networks, systems and the like.

The casino server 24 may be configured to implement a variety of functionality (and/or there may be a plurality of different servers which each implement different functionality). For example, the casino server(s) 24 may implement accounting functionality. The accounting functionality may comprise tracking of wagers made by players at each gaming machine, winnings paid to players at each gaming machine, and tracking or determining the amount of earnings (generally referred to as the “house hold”) for each gaming machine. It will be appreciated that the earnings associated with a gaming machine during an interval of time might be positive (a profit) or negative (a loss).

The gaming system(s) might also comprise or include an online casino OC. The online casino OC may include one or more computing devices, such as servers 23, for presenting one or more wagering games online.

The system 20 may further comprise a provider system P. The provider system P may be configured to allow users to purchase interests in wagering game outcomes, track those interests, and allocate earnings relating to those interests. As used herein, these interests may be referred to as “game asset interests.” As described in more detail below, these interests may comprise an interest in the earnings of one or more games, such as the earnings associated with a particular gaming machine (as a result of the play by players thereof), such as during a period of time.

In one embodiment, the provider system P may comprise one or more processing servers 28. These servers 28 may be similar to the casino server(s) 24 noted above (such as including a processor, memory, communication interface, etc.). The processing server 28 preferably runs or executes software for implementing the functionality described herein.

In one embodiment, the processing server 28 may include, or communicate with, one or more databases 30. The database 30 may store information, such as user accounts, information regarding user game asset interests, allocated earnings, etc., as described in more detail below.

The system 20 also comprises, or may communicate with, one or more user devices 32. The user devices 32 may comprise computing devices, such a mobile communication device, PDA, laptop, tablet, desktop, workstation, etc. The user devices 32 may thus include a processor, a memory, machine-readable code stored in the memory and executable by the processor, at least one video display, at least one user input device, and the like.

In one embodiment, aspects of the system 20 may communicate with one another, such as via one or more communication links 34, including WANs, LANs, the Internet, etc. Such communications may be wired or wireless, using various protocols.

In one embodiment of the invention, the system 20 allows a user (an individual, business, association, etc.) to obtain a game asset interest. In one configuration, the user purchases the game asset interest.

The game asset interest comprises an interest (such as a whole or partial interest, such as a percentage between 1 and 100) of the earnings (which may be positive or negative (e.g. a loss)) associated with the play of one or more wagering games, such as presented by one or more gaming machines 22, one or more gaming tables, one or more online games or the like. Preferably, the interest relates to the earnings from such wagering games during a designated time period. This period may have a start time and an end time and/or might comprise a designated duration of time, such as one or more hours, days, weeks, etc.

In one embodiment, the system 20 is configured to track the earnings associated with a game asset interest and allocate the earnings to the one or more users thereof.

As one example, User B might purchase a 25% interest in a video poker gaming machine located in Casino A, having Gaming Machine ID #123, for the period of time Jan. 1, 2022, to Jan. 31, 2022, for $1000. During that period of time, players playing that gaming machine may wager $224,200 and the gaming machine may award $213,750 to those players, thus yielding earnings (e.g. a house hold) of $10,450. The system may thus be configured to allocate 25% of those earnings to User B, or $2612.50. Thus, User B would make $1612.50 in net earnings (e.g. the gross earnings of $2612.50 less the $1000 purchase price), or a return of 61.25%.

Of course, the system may permit different users to purchase different interests (by amount of the interest—e.g. 1%, 10%, 50%, etc.), purchase interests in different games (such as different gaming machines, gaming tables, online games, including combinations thereof, such as in the games presented by multiple gaming machines) and for different periods of time. The purchase price may be dependent upon those and/or other factors.

In one embodiment, a user may generate a user account, such as with the processing server 28. The processing server 28 may offer one or more game asset interests for purchase or a user might be permitted to custom create such an interest. As one example, the operator of a casino C might approach a provider with a list of gaming machines and gaming tables and associated interests which the casino C is willing to sell. The provider might then make those interests available for purchase, such as via the processing server 28 (which the user might access by a user device 32).

In one embodiment, the game asset interest might be represented by the user's account, another account or a non-fungible token (NFT). For example, a particular NFT may represent a particular interest in Gaming Machine ID #123 for a particular period of time, and that NFT may be purchased by a user of the system (and might be transferrable, such as sellable by, that user). In one embodiment, the processing server 28 may generate and track the NFTs (although in a preferred embodiment, the NFT exists on a blockchain or similar distributed public ledger).

As indicated, in one embodiment, the game asset interests represent an interest in the earnings from wagering games, and preferably the “non-player earnings”—e.g. the difference between amounts wagered and paid to players for the play of one or more wagering games. Thus, such earnings must be determined. In one configuration, information about game earnings may be obtained by the processing server 28, such as from the casino server 24 (such as from the accounting system), from the online game server 23 or the like. As one example, as indicated above, a casino's accounting system (such as implemented by a casino accounting server) communicates with the gaming machines 22 of the casino, obtaining information about wagers made, payouts, etc., at each gaming machine, thus allowing the casino accounting system to determine the earnings for that gaming machine 22 per game, over a period of time or the like.

In one embodiment, the processing server 28 might communicate directly with the one or more games, such as gaming machines/tables/online game servers, to obtain such information. This information might be obtained and recorded in a blockchain, to as to create a secure/auditable record of information. In one embodiment, the information may be associated with the blockchain that defines the NFT game asset interest.

In one configuration, the user's one or more NFTs may be held in a wallet (e.g., MetaMask).

Earnings may be paid to a user in various manners. For example, earnings may be paid as traditional currency (e.g., USD). The earnings may be associated with a user's wallet. Earnings might also be paid through new currencies like cryptocurrencies (e.g., Bitcoin, Ethereum, etc.).

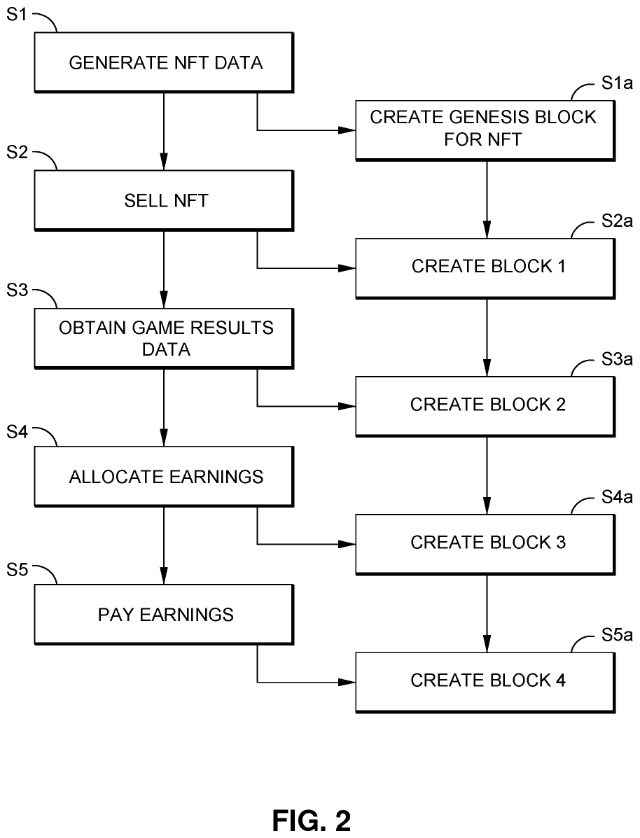

FIG. 2 is a flow diagram which illustrates one embodiment of a method of the invention.

In a step S1, information regarding a game asset interest, such as in the form of an NFT, may be generated, such as by the processing server 28. As indicated, this information may comprise information about the game asset interest, such as the amount of the interest (e.g. percentage interest), game or games which are tied to the interest (such as via machine serial number, table identifier, etc., as described herein), time period of the interest (e.g. start and end time or duration, etc., as described above).

In one embodiment, in a step 1a, a blockchain record is created for the NFT. This record might comprise, for example, a genesis block (often referred to as “block 0”) of a blockchain. The genesis block contains first information regarding the NFT (such as the NFT identifying data described above) and a timestamp. In one embodiment, the first information might comprise information which confirms the creation or existence of the NFT. The first information might comprise “root of trust” or “ROT” information.

In a step S2, the NFT may be sold to a user. Accordingly, in a step S2a, a block 1 may then be created as part of the blockchain off of the genesis block. This block might contain second information regarding the NFT, a second timestamp, and a hash of the genesis block. The second information might comprise, for example, information confirming the purchase of the NFT by a particular identified user (including user identifying information), date of the purchase, amount of the purchase, etc.

In a step S3, game results data is obtained that corresponds to the NFT. As indicated above, this might comprise obtaining information from the particular gaming machine(s) or casino accounting system, regarding the earnings of the one or more games (directly, such as in the form of calculated earnings, or indirectly, such as in the form of amounts wagered and winnings paid, from which earnings may be calculated, etc.). In a step S3a, a block 2 may be then created as part of the blockchain off of block 1. This block may contain the game results data, a third timestamp, and hash of the previous blocks. In the case where game results data is obtain incrementally, step S3a might be repeated as additional sets of game results data are obtained.

In a step S4, earnings associated with the NFT may be allocated. As indicated herein, this might comprise a calculation of the amount of earnings tied to the NFT using the game asset interest percentage and the total earnings for the game(s). In a step S4a, a block 3 may then be created as part of the blockchain off of block 2. This block may contain the earning allocation information, another timestamp and a hash of the previous blocks.

In a step S5, the allocated earnings may be paid to the user (as indicated above, such payment may be made in various forms). In a step S5A, a block 4 may then be created as part of the blockchain off of block 3. This block may contain information confirming payment of the allocated earnings to the user.

Of course, if the NFT is transferred by the user to another user as indicated herein, the blockchain record may be updated in order to reflect the new owner.

Additional aspects of the invention will now be described.

In one embodiment, the user of a game asset interest may be allocated earnings, whether positive or negative. For example, if the game asset interest has negative earnings (e.g. a loss), then the user might be assessed that loss (such as by owing additional monies). As one example, the owner of a game asset interest may be required to place funds into an escrow, such as a wallet escrow (either in traditional currency or cryptocurrency). If the game asset interest has negative earnings, the allocated loss is applied to the user's account, such as by removing the allocated loss from the user's wallet escrow (such as for transfer to the processor's wallet or account.

As another example of the invention, the owner of a game asset interest may be allocated or paid a flat fee if the game asset achieves a certain target(s). For example, if a gaming machine has earnings of $1,000 or more in a month, the user might be allocated or paid $100.

The principles of the invention may be applied to all types of monetary or monetary-value prize games, including but not limited to slot machines, table games, iGaming and skill-based gaming.

As one aspect of the invention, a user is now able to participate in gaming as the “house” with the “house advantage” being in their favor. In particular, players of traditional casino games, iGaming and skill-based games can participate in the long-term house advantage of the game operator by owning a game asset interest. They may hedge their risk as players by owning the “other side” of the bet to diversify their payouts beyond their own performance. Moreover, they can participate in aggregate gaming (e.g. the results of multiple games played) rather than individual gameplay, and in the play by third parties.

Another aspect of the invention is that a game operator is able to diversify and monetize their risk by allowing users to participate in the winnings and losings of their games, rather than bear such entirely on its own. For example, gaming investors that do not own games or operator games can avail themselves of the financial advantage of an individual or group of games without having to invest in a company. The company may have other costs or market conditions which affect the value investment in the company, which decreases the value of the investment or increases its risk. By owning the invention, the gaming investors can focus their investment on the game itself.

For example, game owners and operators diversify the risk of game operations with the owners of the game asset interests. The game owners and operators share the winnings and losings of a game, reducing their risk in the case that the losings are shared with the game asset interest owners. Moreover, game owners and operators can sell the game asset interests to create capital before the game is operating, or during its operations after a period of demonstrated payouts. For example, a game owner can sell 15% of the winnings of a game in an NFT that would be priced at the expected winnings over an entire year. The game owners and operators would then be capitalizing the first-year payout, funding operations and expansion. The game asset interests, such as represented by NFTs, can also be sold or transferred. For example, a game asset interest by a user might generate earnings and the user might sell that game asset interest, such as by selling the NFT representing that interest, for a profit to a third party.

While in one embodiment of the invention the system may comprise a plurality of servers, such as a casino or casino accounting server, an online server and provider server that communicate with one another, it will be appreciated that in some embodiments, additional servers or systems may be communicatively coupled and be configured to implement the functionality described herein and/or fewer servers (such as a single casino server which implements both casino accounting and the provider functionality described herein) might be utilized.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A system for tracking casino game asset interests and allocating earnings associated therewith comprising:
at least one external server comprising a processor, a memory and machine-readable code stored in said memory and executable by said processor to cause said server to:
generate information which identifies a game asset interest;
create a record regarding said game asset interest, said record comprising an initial block having said information which identifies said game asset interest and first time information associated therewith;
transmit information regarding said initial block to at least one other computing device for decentralized storage;
receive information regarding earnings associated with said game asset interest during a period of time;
create a second block for said record, said second block having said information regarding said earnings and second time information associated therewith;
transmit information regarding said second block to said at least one other computing device;
determine a payment amount based upon said earnings;
create a third block for said record, said third block having said information regarding said payment amount and third time information associated therewith; and
transmit information regarding said third block to said at least one other computing device.

2. The system in accordance with claim 1, wherein said information which identifies said game asset interest comprises information identifying a non-fungible token.

3. The system in accordance with claim 1, wherein said information which identifies said game asset interest comprises information which identifies a particular casino gaming machine.

4. The system in accordance with claim 3, wherein said information which identifies said particular gaming machine comprises a gaming machine ID number.

5. The system in accordance with claim 3, wherein said step of receiving information regarding earnings comprises receiving, from said casino gaming machine, wager information.

6. The system in accordance with claim 3, wherein said step of receiving information regarding earnings comprises receiving, from a casino server, accounting information relating to said gaming machine.

7. The system in accordance with claim 1, wherein said payment amount comprises a percentage of said earnings.

8. The system in accordance with claim 1, wherein said machine-readable code stored in said memory and executable by said processor is further configured to cause said server to receive information regarding a transfer of ownership of said game asset interest, to create an additional block for said record, said additional block having said information regarding said transfer and time information associated therewith, and to transmit information regarding said additional block to said at least one other computing device.

9. The system in accordance with claim 8, wherein said game asset interest is represented by a non-fungible token and said information regarding said transfer of ownership comprises information regarding transfer of said non-fungible token.

10. The system in accordance with claim 1, wherein said game asset interest comprises an interest in the earnings associated with at least one casino game.

11. The system in accordance with claim 10, wherein said casino game comprises at least one of: a gaming machine, a gaming table and an online game.

12. The system in accordance with claim 10, wherein said earnings comprise a house hold during a period of time.

13. A system for tracking casino game asset interests and allocating earnings associated therewith comprising:
a casino gaming machine configured to present at least one wager-based game to a player thereof, said game having an outcome, wherein one or more outcomes of said game are losing and where at least one outcome is winning and has an associated award, said gaming machine configured to transmit accounting information, said accounting information comprising information regarding wagers placed to play said game and awards awarded for winning outcomes during a period of time;
a non-fungible token (NFT), said NFT representing an interest in said earnings of said gaming machine; and
a server comprising a processor, a memory and machine-readable code stored in said memory and executable by said processor to cause said server to:
receive information which identifies said NFT;
create a record regarding said interest, said record comprising an initial block having said information which identifies said NFT and first time information associated therewith;
transmit information regarding said initial block to at least one other computing device for decentralized storage;
receive earnings information during said period of time, said earnings information determined from said accounting information from said gaming machine;
create a second block for said record, said second block having said information regarding said earnings and second time information associated therewith;
transmit information regarding said second block to said at least one other computing device;
determine a payment amount based upon said earnings;
create a third block for said record, said third block having said information regarding said payment amount and third time information associated therewith; and
transmit information regarding said third block to said at least one other computing device.

14. The system in accordance with claim 13, wherein said earnings information is received from a casino accounting system which communicates with said gaming machine.

15. The system in accordance with claim 13, wherein said machine-readable code stored in said memory and executable by said processor is further configured to cause said server to receive information regarding a transfer of ownership of said NFT to create an additional block for said record, said additional block having said information regarding said transfer and time information associated therewith, and to transmit information regarding said additional block to said at least one other computing device.

16. The system in accordance with claim 13, wherein said information which identifies said NFT comprises information regarding an owner of said NFT.

17. The system in accordance with claim 13, wherein said NFT is associated with a wallet.

18. The system in accordance with claim 17, wherein said machine-readable code stored in said memory and executable by said processor is further configured to cause said server to transmit instructions to a financial network to transmit funds in the amount of said payment to said wallet.

19. A method for tracking casino game asset interests and allocating earnings associated therewith comprising:
creating, via a computing device, a non-fungible token (NFT) associated with an interest in earnings associated with at least one casino game during a period of time;
receiving information regarding a purchaser of said NFT, said NFT associated with a wallet of said purchaser;
storing, in a memory associated with said computing device, information regarding said NFT, including said purchaser thereof;
receiving, from a gaming system, information regarding earning associated with said at least one casino game during said period of time;
storing information regarding said earnings in association with said NFT; and
transmitting, to said wallet, payment in the amount of said earnings.

20. The method in accordance with claim 19, wherein said at least one casino game comprises at least one of a casino table game, a casino online game and a casino gaming machine game.
